(19) United States
(12) Patent Application Publication
(10) Pub. No.: US 2007/0219095 A1
(43) Pub. Date: Sep. 20, 2007

(54) AQUEOUS SUSPENSION CONCENTRATES

(75) Inventors: Gerhard Frisch, Wehrheim (DE); Ulrike Ebersold, Hattersheim (DE)

Correspondence Address: FROMMER LAWRENCE & HAUG, 745 FIFTH AVENUE- 10TH FL., NEW YORK, NY, 10151, US

(73) Assignee: Bayer CropScience GmbH, Frankfurt (DE)

(21) Appl. No.: 11/685,491

(22) Filed: Mar. 13, 2007

(30) Foreign Application Priority Data
Mar. 15, 2006 (EP) 06005242.0

(51) Int. Cl. A01N 43/64

(52) U.S. Cl. 504/127; 504/133; 504/358

(57) ABSTRACT

The invention relates to aqueous suspension concentrates which comprise
(1) one or more active substances from the group consisting of herbicidally effective 2,4-diamino-s-triazines which are N-substituted on an amino group with a (hetero)aryl(hetero)alkyl group,
(2) one or more active substances from the group consisting of herbicidally effective derivatives, comprising phosphate groups, of the amino acids glycine/homoalanine,
(3) one or more surfactants based on non-salt-like substituted phenol ethers,
(4) one or more thickeners, preferably thickeners based on aluminum silicate, and
(5) optionally additional formulation auxiliaries, and also
(6) optionally additional surfactants other than component (3).

In addition to high stability of the active substances in the formulations, a better biological action is obtained with the same amount expended.

The invention relates to the technical field of the formulations of active substances for use in plant protection. Specifically, the invention relates to formulations for active substance combinations which comprise, inter alia, active substances with polar groups (such as amino groups and both aromatic and heteroaromatic radicals) and broad-spectrum nonselective active substances.

Plant protection compositions can in principle be formulated in different ways, it being possible for the properties of the active substances and type of the formulation to raise problems with regard to the ease of preparation, stability, applicability and effectiveness of the formulations. This applies in particular for active substance combinations which can be composed of different active substance groups. In addition, some formulations are more advantageous than others for economic and ecological reasons and accordingly may be preferred.

One of the active substance groups to be formulated is composed of numerous compounds from a novel group of 2,4-diamino-s-triazines which are N-substituted on an amino group with a (hetero)aryl(hetero)alkyl group. These 2,4-diamino-s-triazines are well known as herbicidal active substances for the combating of undesirable plant growth, for example of harmful plants in plant crops or plantations or on non-crop areas; see, for example, WO-A-97/08156, WO-A-97/29095, WO-A-97/31904, DE-A-19826670, WO-A-98/15536, WO-A-98/15537, WO-A-98/15538, WO-A-98/15539 and also DE-A-19828519, WO-A-98/34925, WO-A-98/42684, WO-A-99/18100, WO-A-99/19309, WO-A-99/37627, WO-A-99/65882, WO-A-00/16627, WO-A-00/69854, WO-A-03/070710, EP-A-1484324, WO-A-04/069814 and the literature cited in the publications.

The compounds first differ from the widely known 2,4-diaminotriazines of older type, such as atrazine or simazine, which are N,N′-dialkyl-substituted, in the aryl or heteroaryl groups bonded to an amino group via (cyclo)aliphatic bridges, which aryl or heteroaryl groups are described here, together with the bridge, in abbreviated form as (hetero)aryl(hetero)alkyl groups. They comprise arylalkyl and heteroarylalkyl groups which can also comprise, in the alkyl bridge, heteroatoms from the group consisting of O, S and N, it being possible for the respective alkyl bridge also to be cyclically bridged with the bridge or the (hetero)aryl radical and accordingly also to form bicyclic radicals with the (hetero)aromatic compound. Because of the different chemical structure, these 2,4-diamino-s-triazines exhibit different biological and physico chemical characteristics from the abovementioned conventional 2,4-diamino-s-triazines.

The other active substance group to be formulated concerns well known broad-spectrum nonselective herbicides from the group consisting of derivatives, comprising phosphate groups, of the amino acids glycine or homoalanine (glycine/homolanine), such as, for example, the compounds glufosinate, bialaphos, glyphosate and sulfosate.

Diverse reasons exist for the combination of different active substance groups in the application, such as, for example, covering over deficiencies in effectiveness which may be present with regard to specific types of harmful plants; general extension of the duration of effects of a herbicidal application; overcoming of reduced susceptibility of harmful plants (herbicidal tolerance or resistance) which can occur with relatively lengthy, one-sided application of certain herbicides, generally geographically limited; lowering the amounts expended necessary for the application, by which not only is the amount of active substance necessary for the application reduced but also the amount of formulation auxiliaries is reduced.

It is accordingly desirable to have combinations of active substances with high formulation stability and the greatest possible synergistically strengthened action. Thus, synergistic effects bring about a reduction in the amounts of the individual active substances expended, an enhanced potency against the same type of harmful plant with an equal amount expended, the control of types hitherto not included (deficiencies in effectiveness), an extension in the application period and/or a reduction in the number of individual applications necessary (duration of effect) and, as a consequence for the user, economically and ecologically more advantageous weed control systems.

For this, however, certain effective ratios of quantities between the individual active substances groups are frequently to be kept to, which ideally can be guaranteed only by specific active substance combination formulations (synonym: mixed formulations, coformulations). Admittedly, phenomena of physical and biological incompatibility not infrequently occur with the combined application of several active substances or active substance groups, e.g. lack of stability in the formulation by decomposition of individual or all active substances, but antagonistic effects of the active substances after application also occur, which can lower or completely eliminate the biological effectiveness.

The object was now to make available specific active substance combination formulations (synonym: mixed formulations, coformulations), in particular for active substance combinations from the group consisting of the abovementioned novel 2,4-diamino-s-triazines and the group consisting of derivatives, comprising phosphate groups, of the amino acids glycine/alanine, which exhibit advantageous properties, such as a better biological action in combination with a high stability of the mixed components in the formulation.

Surprisingly, it has been found that this object is achieved by the aqueous suspension concentrates of the present invention.

A subject matter of the invention is an aqueous suspension concentrate which comprises
(1) one or more active substances from the group consisting of herbicidally effective 2,4-diamino-s-triazines which are N-substituted on an amino group with a (hetero)aryl(hetero)alkyl group,
(2) one or more active substances from the group consisting of herbicidally effective derivatives, comprising phosphate groups, of the amino acids glycine/alanine,
(3) one or more surfactants based on non-salt-like substituted phenol ethers,
(4) one or more thickeners, preferably thickeners based on aluminum silicate.

In addition, the aqueous suspension concentrates according to the invention can comprise additional components, for example:
(5) additional formulation auxiliaries, and
(6) additional surfactants other than component (3).

Water-based formulations generally have the advantage that they require little or no organic solvents.

Aqueous suspension concentrates for the formulation of active substances are well known from the agrochemical, pharmaceutical, veterinary medicine and paint and varnish fields. Thus, aqueous suspension concentrates of plant protection agents are disclosed, for example in EP-A-0110174, just like more highly concentrated aqueous suspension concentrates, such as, e.g., of sulfur in EP-A-0220655 and metamitron in EP-A-0620971. A mixture of formaldehyde condensation products or lignosulfonates and wetting agents is preferably used here.

The term “aqueous suspension concentrates” is to be understood as meaning suspension concentrates based on water. The proportion of water in the suspension concentrates according to the invention can vary within a wide range and is preferably from 25 to 98% by weight, in particular from 35 to 85% by weight; in this connection, the specification “% by weight”, here and throughout the description, unless otherwise specified, refers to the relative weight of the respective component, based on the total weight of the formulation.

Suitable active substances of the type of the abovementioned novel 2,4-diamino-s-triazines (component 1) are the active substances known from the patent publications already cited, in particular 2,4-diamino-6-(halo)(cyclo)alkyl-s-triazine compounds, which are substituted on an amino group with arylalkyl, heteroarylalkyl, aryloxyalkyl, heteroaryloxyalkyl, arylalkoxyalkyl or heteroarylalkoxyalkyl radicals or bicyclic radicals, preferably, in this connection, bicyclic radicals, in which the ring lying further from the bonding position is aromatic or heteroaromatic.

Examples of suitable 2,4-diamino-s-triazines from the abovementioned group are compounds of the formulae (I), (II), (III) and (IV) mentioned below, i.e.

1. Compounds of the formula (I) and the salts thereof,

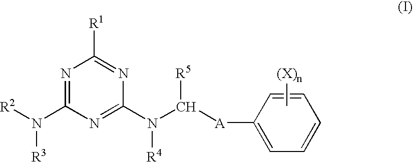

in which
R¹ is (C₁-C₆)alkyl, which is unsubstituted or substituted by one or more radicals from the group consisting of halogen, cyano, nitro, thiocyanato, (C₁-C₄)alkoxy, (C₁-C₄)alkylthio, (C₁-C₄)alkylsulfinyl, (C₁-C₄)alkylsulfonyl, (C₂-C₄)alkenyl, (C₂-C₄)alkynyl, phenyl, which is unsubstituted or substituted, and heterocyclyl with 3 to 6 ring atoms and 1 to 3 ring heteroatoms from the group consisting of N, O and S, it being possible for the ring to be unsubstituted or substituted,
R² and R³ are, in each case independently of one another, hydrogen, amino or alkylamino or dialkylamino with in each case 1 to 6 carbon atoms in the alkyl radical, an acyclic or cyclic hydrocarbon radical or hydrocarbyloxy radical with in each case 1 to 10 carbon atoms or a heterocyclyl radical, heterocyclyloxy radical or heterocyclylamino radical with in each case 3 to 6 ring atoms and 1 to 3 ring heteroatoms from the group consisting of N, O and S, it being possible for each of the five lastmentioned radicals to be unsubstituted or substituted, or an acyl radical or
R² and R³, together with the nitrogen atom of the NR²R³ group, are a heterocyclic radical with 3 to 6 ring atoms and 1 to 4 ring heteroatoms, the optional additional ring heteroatoms, in addition to the nitrogen atom, being chosen from the group consisting of N, O and S and the radical being unsubstituted or substituted,
R⁴ is hydrogen, amino, alkylamino or dialkylamino with in each case 1 to 6 carbon atoms in the alkyl radical, an acyclic or cyclic hydrocarbon radical or hydrocarbyloxy radical with in each case 1 to 10 carbon atoms, preferably with 1 to 6 carbon atoms, or a heterocyclyl radical, heterocyclyloxy radical or heterocyclylamino radical with in each case 3 to 6 ring atoms and 1 to 3 ring heteroatoms from the group consisting of N, O and S, each of the five last-mentioned radicals being unsubstituted or substituted, or an acyl radical,
R⁵ is hydrogen, halogen, nitro, cyano, thiocyanato or a radical of the formula —B¹—Y¹, B¹ and Y¹ being as defined below,
A is alkylene with 1 to 5 linearly connected carbon atoms or alkenylene or alkynylene radical with in each case 2 to 5 linearly connected carbon atoms, each of the three lastmentioned diradicals being unsubstituted or substituted by one or more radicals from the group consisting of halogen, nitro, cyano, thiocyanato and a radical of the formula —B²—Y²,
(X)ₙ are n substituents X and in this connection X are, in each case independently of one another, halogen, (C₁-C₆)alkyl, (C₂-C₆)alkenyl, (C₂-C₆)alkynyl, (C₁-C₆)alkoxy, (C₂-C₆)alkenyloxy, (C₂-C₆)alkynyloxy, [(C₁-C₄)alkyl]carbonyl, [(C₁-C₄)alkoxy]-carbonyl or [(C₁-C₄)alkylthio]carbonyl, the hydrocarbon-comprising parts in the 9 lastmentioned radicals being unsubstituted or substituted, or a radical of the formula —B⁰—R⁰, B⁰ being as defined below and R⁰ being an aromatic, saturated or partially saturated carbocyclic or heterocyclic radical, the cyclic radical being unsubstituted or substituted, or two adjacent radicals X are together a fused-on ring with 4 to 6 ring atoms which is carbocyclic or comprises ring heteroatoms from the group consisting of O, S and N and which is unsubstituted or substituted by one or more radicals from the group consisting of halogen, (C₁-C₄)alkyl and oxo,
n is 0, 1, 2, 3, 4 or 5,
B⁰, B¹, B² are, in each case independently of one another, a direct bond or a divalent group of the formula —O—, —S(O)ₚ—, —S(O)ₚ—O—, —O—S(O)ₚ—, —CO—, —O—CO—, —CO—O—, —NR′—, —O—NR′—, —NR′—O—, —NR′—CO— or —CO—NR′—, p being 0, 1 or 2 and R′ being hydrogen, alkyl with 1 to 6 carbon atoms, phenyl, benzyl, cycloalkyl with 3 to 6 carbon atoms or alkanoyl with 1 to 6 carbon atoms,
Y¹, Y² are, in each case independently of one another, H or an acyclic hydrocarbon radical, for example each with 1 to 20 carbon atoms, or a cyclic hydrocarbon radical with 3 to 8 carbon atoms or a heterocyclic radical with 3 to 9 ring atoms and 1 to 3 ring heteroatoms from the group consisting of N, O and S, each of the three lastmentioned radicals being unsubstituted or substituted;

2. Compounds of the formula (II) or the salts thereof,

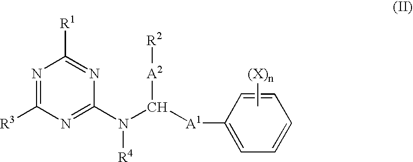

in which
R¹ is aryl, which is unsubstituted or substituted, or (C₃-C₉)cycloalkyl, which is unsubstituted or substituted, or heterocyclyl, which is unsubstituted or substituted, or (C₁-C₆)alkyl, (C₂-C₆)alkenyl or (C₂-C₆)alkynyl, each of the 3 lastmentioned radicals being unsubstituted or substituted by one or more radicals from the group consisting of halogen, hydroxyl, cyano, nitro, thiocyanato, (C₁-C₄)alkoxy, (C₁-C₄)haloalkoxy, (C₂-C₄)alkenyloxy, (C₂-C₄)haloalkenyloxy, (C₁-C₄)alkylthio, (C₁-C₄)alkylsulfinyl, (C₁-C₄)alkylsulfonyl, (C₁-C₄)haloalkylsulfinyl, (C₁-C₄)haloalkylsulfonyl and (C₃-C₉)cycloalkyl, which is unsubstituted or substituted, and phenyl, which is unsubstituted or substituted, and heterocyclyl, which is unsubstituted or substituted, and radicals of the formulae R′—C(=Z′)-, R′—C(=Z′)-Z-, R′-Z-C(=Z′)-, R′R″N—C(=Z′)-, R′-Z-C(=Z′)-O—, R′R″N—C(=Z′)-Z-, R′—C(=Z′)-NR″— and R′R″N—C(=Z′)-NR′″—, in which R′, R″ and R′″ are, in each case independently of one another, (C₁-C₆)alkyl, aryl, aryl(C₁-C₆)alkyl, (C₃-C₉)cycloalkyl or (C₃-C₉)cycloalkyl(C₁-C₆)alkyl, each of the 5 lastmentioned radicals being unsubstituted or substituted, and in which Z and Z′ are, independently of one another, in each case an oxygen or sulfur atom,
R² is (C₃-C₉)cycloalkyl, which is unsubstituted or substituted, (C₄-C₉)cycloalkenyl, which is unsubstituted or substituted, heterocyclyl, which is unsubstituted or substituted, or phenyl, which is unsubstituted or substituted, or
R³ is a radical of the formula —N(B¹-D¹)(B²-D²) or —NR—N(B¹-D¹)(B²-D²), in which in each case B¹, B², D¹ and D² are as defined below and R′ is hydrogen, (C₁-C₆)alkyl or [(C₁-C₄)alkyl]carbonyl,
R⁴ is a radical of the formula —B³-D³, B³ and D³ being as defined below,
A¹ is straight-chain alkylene with 1 to 5 carbon atoms or straight-chain alkenylene or alkynylene with in each case 2 to 5 carbon atoms, each of the three lastmentioned diradicals being unsubstituted or substituted by one or more radicals from the group consisting of halogen, nitro, cyano, thiocyanato and radicals of the formula —B⁴-D⁴, B⁴ and D⁴ being as defined below,
A² is a direct bond or straight-chain alkylene with 1 to 4 carbon atoms or straight-chain alkenylene or alkynylene with in each case 2 to 5 carbon atoms, each of the three lastmentioned diradicals being unsubstituted or substituted by one or more radicals from the group consisting of halogen, nitro, cyano, thiocyanato and radicals of the formula —B⁵-D⁵, or a divalent radical of the formula V¹, V², V³, V⁴ or V⁵,

—CR⁶R⁷—W*—CR⁸R⁹— (V¹)

—CR¹⁰R¹¹—W*—CR¹²R¹³—CR¹⁴R¹⁵— (V²)

—CR¹⁶R¹⁷—CR¹⁸R⁹—W*—CR²⁰R²¹— (V³)

—CR²²R²³—CR²⁴R²⁵—W*— (V⁴)

—CR²⁶R²⁷—W*— (V⁵)
each of the radicals R⁶ to R²⁷ being, in each case independently of one another, hydrogen, halogen, nitro, cyano, thiocyanato or a radical of the formula —B⁶-D⁶,
W* being in each case an oxygen atom, a sulfur atom or a group of the formula N(B⁷-D⁷) and
B⁵, B⁶, B⁷, D⁵, D⁶ and D⁷ being as defined below,
B¹, B², B³ and B⁷ are, in each case independently of one another, a direct bond or a divalent group of the formulae —C(=Z*)-, —C(=Z*)-Z**-, —C(=Z*)-NH— or —C(=Z*)-NR*—, Z* being an oxygen or sulfur atom, Z** being an oxygen or sulfur atom and R* being (C₁-C₆)alkyl, aryl, aryl(C₁-C₆)alkyl, (C₃-C₉)cycloalkyl or (C₃-C₉)cycloalkyl(C₁-C₆)alkyl, each of the 5 lastmentioned radicals being unsubstituted or substituted,
B⁴, B⁵ and B⁶ are, in each case independently of one another, a direct bond or a divalent group of the formulae —O—, —S(O)ₚ—, —S(O)ₚ—O—, —O—S(O)ₚ—, —CO—, —O—CO—, —CO—O—, −S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, p being the integer 0, 1 or 2 and R^{O} being hydrogen, (C₁-C₆)alkyl, aryl, aryl(C₁-C₆)alkyl, (C₃-C₉)cycloalkyl or (C₃-C₉)cycloalkyl(C₁-C₆)alkyl, each of the 5 lastmentioned radicals being unsubstituted or substituted,
D¹, D², D³, D⁴, D⁵ D⁶ and D⁷ are, in each case independently of one another, hydrogen, (C₁-C₆)alkyl, aryl, aryl(C₁-C₆)alkyl, (C₃-C₉)cycloalkyl or (C₃-C₉)cycloalkyl(C₁-C₆)alkyl, each of the 5 lastmentioned radicals being unsubstituted or substituted, or in each case two radicals D⁵ of two groups —B⁵-D⁵ bonded to a carbon atom are bonded to one another and produce an alkylene group with 2 to 4 carbon atoms which is unsubstituted or substituted by one or more radicals from the group consisting of (C₁-C₄)alkyl and (C₁-C₄)alkoxy,
(X)n are n substituents X and in this connection X are, in each case independently of one another, halogen, hydroxyl, amino, nitro, formyl, carboxyl, cyano, thiocyanato, aminocarbonyl or (C₁-C₆)alkyl, (C₁-C₆)alkoxy, (C₁-C₆)alkylthio, mono(C₁-C₆)alkylamino, di(C₁-C₄)alkylamino, (C₂-C₆)alkenyl, (C₂-C₆)alkynyl, [(C₁-C₆)alkyl]carbonyl, [(C₁-C₆)alkoxy]carbonyl, mono(C₁-C₆)alkylamino-carbonyl, di(C₁-C₄)alkylaminocarbonyl, N—(C₁-C₆)alkanoylamino or N—(C₁-C₄)alkanoyl-N—(C₁-C₄)alkylamino, each of the 13 lastmentioned radicals being unsubstituted or substituted, preferably unsubstituted or substituted by one or more radicals from the group consisting of halogen, hydroxyl, amino, nitro, formyl, carboxyl, cyano, thiocyanato, (C₁-C₄)alkoxy, (C₁-C₄)haloalkoxy, (C₁-C₄)alkylthio, (C₁-C₄)haloalkylthio, mono(C₁-C₄)alkylamino, di(C₁-C₄)alkylamino, (C₃-C₉)cycloalkyl, (C₃-C₉)cycloalkylamino, [(C₁-C₄)alkyl]carbonyl, [(C₁-C₄)alkoxy]carbonyl, aminocarbonyl, mono(C₁-C₄)alkylaminocarbonyl, di(C₁-C₄)alkylaminocarbonyl, phenyl, phenoxy, phenylthio, phenylcarbonyl, heterocyclyl, heterocyclyloxy, heterocyclylthio and heterocyclylamino, each of the 8 lastmentioned radicals being unsubstituted or exhibiting one or more substituents from the group consisting of halogen, nitro, cyano, (C₁-C₄)alkyl, (C₁-C₄)alkoxy, (C₁-C₄)alkylthio, (C₁-C₄)haloalkyl, (C₁-C₄)haloalkoxy, formyl, (C₁-C₄)alkyl-carbonyl and (C₁-C₄)alkoxycarbonyl, or returning to X (C₃-C₉)cycloalkyl, (C₃-C₉)cycloalkoxy, (C₃-C₉)cycloalkylamino, phenyl, phenoxy, phenylthio, phenylcarbonyl, heterocyclyl, heterocyclyloxy, heterocyclylthio or heterocyclylamino, each of the 11 lastmentioned radicals being unsubstituted or substituted, or two adjacent radicals X are together a fused-on ring with 4 to 6 ring atoms which is carbocyclic or comprises ring heteroatoms from the group consisting of O, S and N and which is unsubstituted or substituted by one or more radicals from the group consisting of halogen, (C₁-C₄)alkyl and oxo,
n is0, 1, 3, 4 or 5 and
“heterocyclyl” in the abovementioned radicals is, in each case independently of the others, a heterocyclic radical with 3 to 7 ring atoms and 1 to 3 heteroatoms from the group consisting of N, O and S,
preferably
a) the total amount of the carbon atoms in the radicals A¹ and A²-R² being at least 6 carbon atoms or
b) the total amount of the carbon atoms in the radicals A¹ and A²-R² being 5 carbon atoms and A¹ being a group of the formula —CH₂— or —CH₂CH₂— and also R¹ being (C₁-C₄)alkyl, (C₁-C₄)haloalkyl, (C₂-C₆)haloalkenyl or (C₃-C₉)cycloalkyl which is unsubstituted or substituted;

3. Compounds of the formula (III) and the salts thereof,

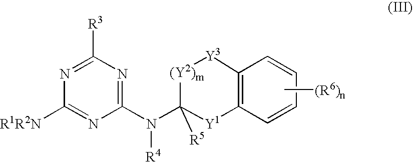

in which
R¹ and R² are, in each case independently of one another, hydrogen, amino, alkylamino or dialkylamino with in each case 1 to 6 carbon atoms in the alkyl radical, an acyclic or cyclic hydrocarbon radical or hydrocarbyloxy radical with in each case 1 to 10 carbon atoms or a heterocyclyl radical, heterocyclyloxy radical, heterocyclylthio radical or heterocyclylamino radical with in each case 3 to 6 ring atoms and 1 to 3 ring heteroatoms from the group consisting of N, O and S, each of the five lastmentioned radicals being unsubstituted or substituted, or an acyl radical or
R¹ and R² are, together with the nitrogen atom of the NR¹R² group, a heterocyclic radical with 3 to 6 ring atoms and 1 to 4 ring heteroatoms, the optional additional ring heteroatoms in addition to the nitrogen atom being chosen from the group consisting of N, O and S and the radical being unsubstituted or substituted,
R³ is halogen, cyano, thiocyanato, nitro or a radical of the formula -Z¹-R⁷,
R⁴ is hydrogen, amino, alkylamino or dialkylamino with in each case 1 to 6 carbon atoms in the alkyl radical, an acyclic or cyclic hydrocarbon radical or hydrocarbyloxy radical with in each case 1 to 10 carbon atoms or a heterocyclyl radical, heterocyclyloxy radical or heterocyclylamino radical with in each case 3 to 6 ring atoms and 1 to 3 ring heteroatoms from the group consisting of N, O and S, each of the five lastmentioned radicals being unsubstituted or substituted, or an acyl radical,
R⁵ is halogen, cyano, thiocyanato, nitro or a radical of the formula -Z²-R⁸,
R⁶ is, if n=1, or the radicals R⁶ are, in each case independently of one another, if n is greater than 1, halogen, cyano, thiocyanato, nitro or a group of the formula -Z³-R⁹,
R⁷, R⁸, R⁹ are, in each case independently of one another,
   hydrogen or
   an acyclic hydrocarbon radical, it being possible for carbon atoms in the chain to be substituted by heteroatoms from the group consisting of N, O and S, or
   a cyclic hydrocarbon radical or
   a heterocyclic radical,
each of the 3 lastmentioned radicals being unsubstituted or substituted,
Z¹, Z², Z³ are, in each case independently of one another,
   a direct bond or
   a divalent group of the formula —O—, —S(O)ₚ—, —S(O)ₚ—O—, —O—S(O)ₚ—, —CO—, —CS—, —S—CO—, —CO—S—, —O—CS—, —CS—O—, —S—CS—, —CS—S—, —OCO—, —CO—O—, —NR′—, —O—NR′—, —NR′—O—, —NR′—CO— or —CO—NR′—, p being 0, 1 or 2 and R′ being hydrogen, alkyl with 1 to 6 carbon atoms, phenyl, benzyl, cycloalkyl with 3 to 6 carbon atoms or alkanoyl with 1 to 6 carbon atoms,
Y¹, Y², Y³ and additional groups Y², if m is 2, 3 or 4, are, in each case independently of one another,
   a divalent group of the formula CR^{a}R^{b}, R^{a} and R^{b} being identical or different and in each case being a radical from the group of the radicals possible for R⁷ to R⁹, or
   a divalent group of the formula —O—, —CO—, —C(═NR*)—, —S(O)_{q}—, —NR — or —N(O)—, q being 0, 1 or 2 and R being hydrogen or alkyl with 1 to 4 carbon atoms, or
   Y¹ or Y³ is a direct bond,
two oxygen atoms of the groups Y² and Y³ not being adjacent,
m is 1, 2, 3 or 4,
n is 0, 1, 2, 3 or 4;

4. Substituted 2,4-diamino-1,3,5-triazines of the general formula (IV),

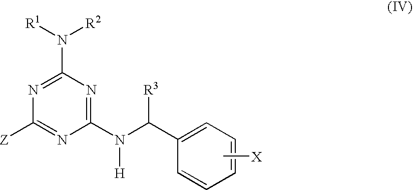

in which
R¹ is hydrogen or alkyl with 1 to 6 carbon atoms optionally substituted by hydroxyl, cyano, halogen or C₁-C₄-alkoxy,
R² is hydrogen, formyl, alkyl, alkylcarbonyl, alkoxycarbonyl or alkylsulfonyl with in each case 1 to 6 carbon atoms in the alkyl groups and in each case optionally substituted by cyano, halogen or C₁-C₄-alkoxy, or phenylcarbonyl, naphthylcarbonyl, phenylsulfonyl or naphthylsulfonyl in each case optionally substituted by cyano, halo-C₁-C₄-alkyl, C₁-C₄-alkoxy, halo-C₁-C₄-alkoxy or C₁-C₄-alkoxycarbonyl,
R³ is alkyl with 1 to 6 carbon atoms optionally substituted by cyano, halogen or C₁-C₄-alkoxy or cycloalkyl with 3 to 6 carbon atoms optionally substituted by cyano, halogen or C₁-C₄-alkyl,
X is a substituent from the following group:
hydroxyl, cyano, nitro, halogen, alkyl or alkoxy with in each case 1 to 6 carbon atoms and in each case optionally substituted by hydroxyl, cyano or halogen, alkylcarbonyl, alkoxycarbonyl, alkylthio, alkylsulfinyl or alkylsulfonyl with in each case 1 to 6 carbon atoms in the alkyl groups and in each case optionally substituted by halogen, or phenyl or phenoxy in each case optionally substituted by hydroxyl, cyano, nitro, halogen, C₁-C₄-alkyl, C₁-C₄-haloalkyl, C₁-C₄-alkoxy or C₁-C₄-haloalkoxy, and
Z is hydrogen, hydroxyl, halogen, alkyl, alkoxy, alkylcarbonyl, alkoxycarbonyl, alkylthio, alkylsulfinyl or alkylsulfonyl with in each case 1 to 6 carbon atoms in the alkyl groups and in each case optionally substituted by hydroxyl, cyano, nitro, halogen, C₁-C₄-alkoxy, C₁-C₄-alkylcarbonyl, C₁-C₄-alkoxycarbonyl, C₁-C₄-alkylthio, C₁-C₄-alkylsulfinyl or C₁-C₄-alkylsulfonyl, alkenyl or alkynyl with in each case 2 to 6 carbon atoms and in each case optionally substituted by halogen, or cycloalkyl with 3 to 6 carbon atoms optionally substituted by cyano, halogen or C₁-C₄-alkyl.

Preference is given to the abovementioned 2,4-diamino-s-triazines of the formulae (I) to (V) which are substituted in the 6 position on the triazine ring with radicals from the group consisting of hydrogen, (C₁-C₆)alkyl, (C₁-C₆)-haloalkyl, (C₃-C₆)cycloalkyl and (C₃-C₆)cycloalkyl(C₁-C₄)alkyl, preferably (C₁-C₄)alkyl and (C₁-C₄)haloalkyl.

The term “halogen-substituted alkyl” (=haloalkyl) means, in this connection, alkyl substituted by one or more halogen atoms from the group consisting of fluorine, chlorine, bromine and iodine, preferably from the group consisting of fluorine, chlorine and bromine, in particular from the group consisting of fluorine and chlorine.

Preference is also given to compounds of the formulae (I) to (V) in which one amino group is unsubstituted, i.e. is NH₂, and the other amino group carries a hydrogen atom and the (hetero)aryl(hetero)alkyl radical.

Preference is given, as active substances, for example, to 2,4-diamino-s-triazines of the formula (Ia)

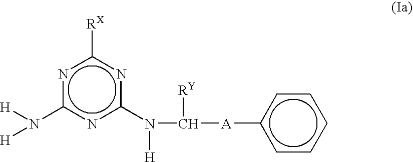

in which
R^{X} is (C₁-C₄)alkyl or (C₁-C₄)haloalkyl;
R^{Y} is (C₁-C₄)alkyl, (C₃-C₆)cycloalkyl or (C₃-C₆)cycloalkyl(C₁-C₄)alkyl and
A is —CH₂—, —CH₂CH₂—, —CH₂CH₂CH₂—, —O—, —CH₂CH₂—O— or —CH₂CH₂CH₂—O—.

Preference is also given to compounds of the formula (III) with bicyclic radicals, such as are known from WO-A-97/31904 or WO-A-04/069814 (see table A):

Preferred active substances from the group of the diaminotriazines are listed by way of example in the following table A.

TABLE A

| No. | Chemical name |
|---|---|
| A-1 | (RS)-2-amino-4-(4-phenyl-1-{cyclopropyl}butylamino)-6-(1-fluoro-1- |
| | methylethyl)-1,3,5-triazine |
| A-2 | (R)-2-aimno-4-(4-phenyl-1-{cyclopropyl}butylamino)-6-(1-fluoro-1-methyl- |
| | ethyl)-1,3,5-triazine |
| A-3 | (S)-2-amino-4-(4-phenyl-1-{cyclopropyl}butylamino)-6-(1-fluoro-1-methyl- |
| | ethyl)-1,3,5-triazine |
| A-4 | 2-amino-4-[(1RS)-4-phenyl-1-{cyclopropyl}butylamino]-6-[(1RS)-1-fluoro- |
| | ethyl]-1,3,5-triazine |
| A-5 | 2-amino-4-[(1R)-4-phenyl-1-{cyclopropyl}butylamino]-6-[(1RS)-1-fluoro- |
| | ethyl]-1,3,5-triazine |
| A-6 | 2-amino-4-[(1S)-4-phenyl-1-{cyclopropyl}butylamino]-6-[(1RS)-1-fluoro- |
| | ethyl]-1,3,5-triazine |
| A-7 | 2-amino-4-[(1R)-4-phenyl-1-{cyclopropyl}butylamino]-6-[(1R)-1-fluoro- |
| | ethyl]-1,3,5-triazine |
| A-8 | 2-amino-4-[(1S)-4-phenyl-1-{cyclopropyl}butylamino]-6-[(1R)-1-fluoro- |
| | ethyl]-1,3,5-triazine |
| A-9 | 2-amino-4-[(1R)-4-phenyl-1-{cyclopropyl}butylamino]-6-[(1S)-1-fluoro- |
| | ethyl]-1,3,5-triazine |
| A-10 | 2-amino-4-[(1S)-4-phenyl-1-{cyclopropyl}butylamino]-6-[(1S)-1-fluoro- |
| | ethyl]-1,3,5-triazine |
| A-11 | (RS)-2-amino-4-(3-phenyl-1-{cyclobutyl}propylamino)-6-(1-fluoro-1-methyl- |
| | ethyl)-1,3,5-triazine |
| A-12 | (R)-2-amino-4-(3-phenyl-1-{cyclobutyl}propylamino)-6-(1-fluoro-1-methyl- |
| | ethyl)-1,3,5-triazine |
| A-13 | (S)-2-amino-4-(3-phenyl-1-{cyclobutyl}propylamino)-6-(1-fluoro-1-methyl- |
| | ethyl)-1,3,5-triazine |
| A-14 | 2-amino-4-[(1RS)-3-phenyl-1-{cyclobutyl}propylamino]-6-[(1RS)-1-fluoro- |
| | ethyl]-1,3,5-triazine |
| A-15 | 2-amino-4-[(1R)-3-phenyl-1-{cyclobutyl}propylamino]-6-[(1RS)-1-fluoro- |
| | ethyl]-1,3,5-triazine |
| A-16 | 2-amino-4-[(1S)-3-phenyl-1-{cyclobutyl}propylamino]-6-[(1RS)-1-fluoro- |
| | ethyl]-1,3,5-triazine |
| A-17 | 2-amino-4-[(1R)-3-phenyl-1-{cyclobutyl}propylamino]-6-[(1R)-1-fluoro- |
| | ethyl]-1,3,5-triazine |
| A-18 | 2-amino-4-[(1S)-3-phenyl-1-{cyclobutyl}propylamino]-6-[(1R)-1-fluoro- |
| | ethyl]-1,3,5-triazine |
| A-19 | 2-amino-4-[(1R)-3-phenyl-1-{cyclobutyl}propylamino]-6-[(1S)-1-fluoro- |
| | ethyl]-1,3,5-triazine |
| A-20 | 2-amino-4-[(1S)-3-phenyl-1-{cyclobutyl}propylamino]-6-[(1S)-1-fluoro- |
| | ethyl]-1,3,5-triazine |
| A-21 | (RS)-2-amino-6-(1-fluoro-1-methylethyl)-4-[1-(3,5-dimethylphenoxy)prop- |
| | 2-ylamino]-1,3,5-triazine |
| A-22 | (R)-2-amino-4-(3-phenyl-1-{cyclobutyl}propylamino)-6-(1-fluoro-1-methyl- |
| | ethyl)-1,3,5-triazine |
| A-23 | (S)-2-amino-4-(3-phenyl-1-{cyclobutyl}propylamino)-6-(1-fluoro-1-methyl- |
| | ethyl)-1,3,5-triazine |
| A-24 | 2-amino-4-[(4RS)-chroman-4-ylamino]-6-(1-fluoro-1-methylethyl)-1,3,5- |
| | triazine |
| A-25 | 2-amino-4-[(4R)-chroman-4-ylamino]-6-(1-fluoro-1-methylethyl)-1,3,5- |
| | triazine |
| A-26 | 2-amino-4-[(4R)-chroman-4-ylamino]-6-[(1RS)-1-fluoroethyl]-1,3,5-triazine |
| A-27 | 2-amino-4-[(4R)-chroman-4-ylamino]-6-[(1R)-1-fluoroethyl]-1,3,5-triazine |
| A-28 | 2-amino-4-[(4R)-chroman-4-ylamino]-6-[(1S)-1-fluoroethyl]-1,3,5-triazine |
| A-29 | 2-amino-4-[(4RS)-7,8-dimethylchroman-4-ylamino]-6-(1-fluoro-1- |
| | methylethyl)-1,3,5-triazine |
| A-30 | 2-amino-4-[(4R)-7,8-dimethylchroman-4-ylamino]-6-(1-fluoro-1- |
| | methylethyl)-1,3,5-triazine |
| A-31 | 2-amino-4-[(1RS)-indan-1-ylamino]-6-(1-fluoro-1-methylethyl)-1,3,5- |
| | triazine |
| A-32 | 2-amino-4-[(1R)-indan-1-ylamino]-6-(1-fluoro-1-methylethyl)-1,3,5-triazine |
| A-33 | 2-amino-4-[(1RS)-6-methylindan-1-ylamino]-6-(1-methylethyl)-1,3,5- |
| | triazine |
| A-34 | 2-amino-4-[(1R)-6-methylindan-1-ylamino]-6-(1-methylethyl)-1,3,5-triazine |
| A-35 | 2-amino-4-[(1RS)-6-fluoroindan-1-ylamino]-6-(1-fluoro-1-methylethyl)- |
| | 1,3,5-triazine |
| A-36 | 2-amino-4-[(1R)-6-fluoroindan-1-ylamino]-6-(1-fluoro-1-methylethyl)-1,3,5- |
| | triazine |
| A-37 | 2-amino-4-[(1RS,2RS)-2-methylindan-1-ylamino]-6-(1-fluoro-1- |
| | methylethyl)-1,3,5-triazine |
| A-38 | 2-amino-4-[(1R,2RS)-2-methylindan-1-ylamino]-6-(1-fluoro-1- |
| | methylethyl)-1,3,5-triazine |
| A-39 | 2-amino-4-[(1R,2S)-2-methylindan-1-ylamino]-6-(1-fluoro-1-methylethyl)- |
| | 1,3,5-triazine |
| A-40 | 2-amino-4-[(1R,2R)-2-methylindan-1-ylamino]-6-(1-fluoro-1-methylethyl)- |
| | 1,3,5-triazine |
| A-41 | 2-amino-4-[(1RS,2RS)-2,6-dimethylindan-1-ylamino]-6-(1-fluoro-1- |
| | methylethyl)-1,3,5-triazine |
| A-42 | 2-amino-4-[(1R,2S)-2,6-dimethylindan-1-ylamino]-6-(1-fluoro-1- |
| | methylethyl)-1,3,5-triazine |
| A-43 | 2-amino-4-[(1R,2R)-2,6-dimethylindan-1-ylamino]-6-(1-fluoro-1- |
| | methylethyl)-1,3,5-triazine |
| A-44 | 2-amino-4-[(1RS,2RS)-6-fluoro-2-methylindan-1-ylamino]-6-(1-fluoro-1- |
| | methylethyl)-1,3,5-triazine |
| A-45 | 2-amino-4-[(1R,2S)-6-fluoro-2-methylindan-1-ylamino]-6-(1-fluoro-1- |
| | methylethyl)-1,3,5-triazine |
| A-46 | 2-amino-4-[(1R,2R)-6-fluoro-2-methylindan-1-ylamino]-6-(1-fluoro-1- |
| | methylethyl)-1,3,5-triazine |
| A-47 | 2-amino-4-[(1RS,2RS)-6-fluoro-2-methylindan-1-ylamino]-6-[(1RS)-1- |
| | fluoroethyl]-1,3,5-triazine |
| A-48 | 2-amino-4-[(1R,2S)-6-fluoro-2-methylindan-1-ylamino]-6-[(1RS)-1-fluoro- |
| | ethyl]-1,3,5-triazine |
| A-49 | 2-amino-4-[(1R,2R)-6-fluoro-2-methylindan-1-ylamino]-6-[(1RS)-1- |
| | fluoroethyl]-1,3,5-triazine |
| A-50 | 2-amino-4-[(1R,2S)-6-fluoro-2-methylindan-1-ylamino]-6-[(1R)-1- |
| | fluoroethyl]-1,3,5-triazine |
| A-51 | 2-amino-4-[(1R,2R)-6-fluoro-2-methylindan-1-ylamino]-6-[(1R)-1- |
| | fluoroethyl]-1,3,5-triazine |
| A-52 | 2-amino-4-[(1R,2S)-6-fluoro-2-methylindan-1-ylamino]-6-[(1S)-1- |
| | fluoroethyl]-1,3,5-triazine |
| A-53 | 2-amino-4-[(1R,2R)-6-fluoro-2-methylindan-1-ylamino]-6-[(1S)-1- |
| | fluoroethyl]-1,3,5-triazine |
| A-54 | 2-amino-4-[(1RS,2RS)-2,6-dimethylindan-1-ylamino]-6-[(1RS)-1- |
| | fluoroethyl]-1,3,5-triazine |
| A-55 | 2-amino-4-[(1R,2S)-2,6-dimethylindan-1-ylamino]-6-[(1RS)-1-fluoroethyl]- |
| | 1,3,5-triazine |
| A-56 | 2-amino-4-[(1R,2R)-2,6-dimethylindan-1-ylamino]-6-[(1RS)-1-fluoroethyl]- |
| | 1,3,5-triazine |
| A-57 | 2-amino-4-[(1R,2S)-2,6-dimethylindan-1-ylamino]-6-[(1R)-1-fluoroethyl]- |
| | 1,3,5-triazine |
| A-58 | 2-amino-4-[(1R,2R)-2,6-dimethylindan-1-ylamino]-6-[(1R)-1-fluoroethyl]- |
| | 1,3,5-triazine |
| A-59 | 2-amino-4-[(1R,2S)-2,6-dimethylindan-1-ylamino]-6-[(1S)-1-fluoroethyl]- |
| | 1,3,5-triazine |
| A-60 | 2-amino-4-[(1R,2R)-2,6-dimethylindan-1-ylamino]-6-[(1S)-1-fluoroethyl]- |
| | 1,3,5-triazine |
| A-61 | 2-amino-4-[(1RS)-4,6-dimethylindan-1-ylamino]-6-(1-fluoro-1- |
| | methylethyl)-1,3,5-triazine |
| A-62 | 2-amino-4-[(1R)-4,6-dimethylindan-1-ylamino]-6-(1-fluoro-1-methylethyl)- |
| | 1,3,5-triazine |
| A-63 | 2-amino-4-[(1RS)-4,6-dimethylindan-1-ylamino]-6-[(1RS)-1-fluoroethyl]- |
| | 1,3,5-triazine |
| A-64 | 2-amino-4-[(1R)-4,6-dimethylindan-1-ylamino]-6-[(1RS)-1-fluoroethyl]- |
| | 1,3,5-triazine |
| A-65 | 2-amino-4-[(1R)-4,6-dimethylindan-1-ylamino]-6-[(1R)-1-fluoroethyl]-1,3,5- |
| | triazine |
| A-66 | 2-amino-4-[(1R)-4,6-dimethylindan-1-ylamino]-6-[(1S)-1-fluoroethyl]-1,3,5- |
| | triazine |
| A-67 | 2-amino-4-[(1RS)-5,6-dimethylindan-1-ylamino]-6-(1-fluoro-1- |
| | methylethyl)-1,3,5-triazine |
| A-68 | 2-amino-4-[(1R)-5,6-dimethylindan-1-ylamino]-6-(1-fluoro-1-methylethyl)- |
| | 1,3,5-triazine |
| A-69 | 2-amino-4-[(1RS)-5,6-dimethylindan-1-ylamino]-6-[(1RS)-1-fluoroethyl]- |
| | 1,3,5-triazine |
| A-70 | 2-amino-4-[(1R)-5,6-dimethylindan-1-ylamino]-6-[(1RS)-1-fluoroethyl]- |
| | 1,3,5-triazine |
| A-71 | 2-amino-4-[(1R)-5,6-dimethylindan-1-ylamino]-6-[(1R)-1-fluoroethyl]-1,3,5- |
| | triazine |
| A-72 | 2-amino-4-[(1R)-5,6-dimethylindan-1-ylamino]-6-[(1S)-1-fluoroethyl]-1,3,5- |
| | triazine |
| A-73 | 2-amino-4-[(1RS)-indan-1-ylamino]-1,3,5-triazine |
| A-74 | 2-amino-4-[(1R)-indan-1-ylamino]-1,3,5-triazine |
| A-75 | 2-amino-4-[(1RS)-6-methylindan-1-ylamino]-1,3,5-triazine |
| A-76 | 2-amino-4-[(1R)-6-methylindan-1-ylamino]-1,3,5-triazine |
| A-77 | 2-amino-4-[(1RS)-6-fluoroindan-1-ylamino]-1,3,5-triazine |
| A-78 | 2-amino-4-[(1R)-6-fluoroindan-1-ylamino]-1,3,5-triazine |
| A-79 | 2-amino-4-[(1RS,2RS)-2-methylindan-1-ylamino]-1,3,5-triazine |
| A-80 | 2-amino-4-[(1R,2S)-2-methylindan-1-ylamino]-1,3,5-triazine |
| A-81 | 2-amino-4-[(1R,2R)-2-methylindan-1-ylamino]-1,3,5-triazine |
| A-82 | 2-amino-4-[(1RS,2RS)-2,6-dimethylindan-1-ylamino]-1,3,5-triazine |
| A-83 | 2-amino-4-[(1R,2S)-2,6-dimethylindan-1-ylamino]-1,3,5-triazine |
| A-84 | 2-amino-4-[(1R,2R)-2,6-dimethylindan-1-ylamino]-1,3,5-triazine |
| A-85 | 2-amino-4-[(1RS)-5,6-dimethylindan-1-ylamino]-1,3,5-triazine |
| A-86 | 2-amino-4-[(1R)-4,6-dimethylindan-1-ylamino]-1,3,5-triazine |
| A-87 | 2-amino-4-[(1RS)-4,6-dimethylindan-1-ylamino]-1,3,5-triazine |
| A-88 | 2-amino-4-[(1R)-4,6-dimethylindan-1-ylamino]-1,3,5-triazine |
| A-89 | 2-amino-4-[(1RS)-5-fluoro-6-methylindan-1-ylamino]-1,3,5-triazine |
| A-90 | 2-amino-4-[(1R)-5-fluoro-6-methylindan-1-ylamino]-1,3,5-triazine |
| A-91 | 2-amino-4-[(1RS)-1,2,3,4-tetrahydronaphth-1-ylamino]-6-(1-fluoro-1- |
| | methylethyl)-1,3,5-triazine |
| A-92 | 2-amino-4-[(1R)-1,2,3,4-tetrahydronaphth-1-ylamino]-6-(1-fluoro-1- |
| | methylethyl)-1,3,5-triazine |
| A-93 | 2-amino-4-[(1RS)-1,2,3,4-tetrahydronaphth-1-ylamino]-6-[(1RS)-1- |
| | fluoroethyl]-1,3,5-triazine |
| A-94 | 2-amino-4-[(1R)-1,2,3,4-tetrahydronaphth-1-ylamino]-6-[(1RS)-1- |
| | fluoroethyl]-1,3,5-triazine |
| A-95 | 2-amino-4-[(1R)-1,2,3,4-tetrahydronaphth-1-ylamino]-6-[(1R)-1- |
| | fluoroethyl]-1,3,5-triazine |
| A-96 | 2-amino-4-[(1R)-1,2,3,4-tetrahydronaphth-1-ylamino]-6-[(1S)-1- |
| | fluoroethyl]-1,3,5-triazine |
| A-97 | 2-amino-4-[(1RS,2RS)-2-methyl-1,2,3,4-tetrahydronaphth-1-ylamino]-6- |
| | (1-fluoro-1-methylethyl)-1,3,5-triazine |
| A-98 | 2-amino-4-[(1R,2S)-2-methyl-1,2,3,4-tetrahydronaphth-1-ylamino]-6-(1- |
| | fluoro-1-methylethyl)-1,3,5-triazine |
| A-99 | 2-amino-4-[(1R,2R)-2-methyl-1,2,3,4-tetrahydronaphth-1-ylamino]-6-(1- |
| | fluoro-1-methylethyl)-1,3,5-triazine |
| A-100 | 2-amino-4-[(1RS,2RS)-2-methyl-1,2,3,4-tetrahydronaphth-1-ylamino]-6- |
| | [(1RS)-1-fluoroethyl]-1,3,5-triazine |
| A-101 | 2-amino-4-[(1R,2S)-2-methyl-1,2,3,4-tetrahydronaphth-1-ylamino]-6- |
| | [(1RS)-1-fluoroethyl]-1,3,5-triazine |
| A-102 | 2-amino-4-[(1R,2R)-2-methyl-1,2,3,4-tetrahydronophth-1-ylamino]-6- |
| | [(1RS)-1-fluoroethyl]-1,3,5-triazine |
| A-103 | 2-amino-4-[(1R,2S)-2-methyl-1,2,3,4-tetrahydronaphth-1-ylamino]-6-[(1S)- |
| | 1-fluoroethyl]-1,3,5-triazine |
| A-104 | 2-amino-4-[(1R,2S)-2-methyl-1,2,3,4-tetrahydronaphth-1-ylamino]-6- |
| | [(1R)-1-fluoroethyl]-1,3,5-triazine |
| A-105 | 2-amino-4-[(1R,2R)-2-methyl-1,2,3,4-tetrahydronaphth-1-ylamino]-6- |
| | [(1R)-1-fluoroethyl]-1,3,5-triazine |
| A-106 | 2-amino-4-[(1R,2R)-2-methyl-1,2,3,4-tetrahydronaphth-1-ylamino]-6- |
| | [(1S)-1-fluoroethyl]-1,3,5-triazine |
| A-107 | 2-amino-4-[(1RS)-6-methyl-1,2,3,4-tetrahydronaphth-1-ylamino]-6-(1- |
| | fluoro-1-methylethyl)-1,3,5-triazine |
| A-108 | 2-amino-4-[(1R)-6-methyl-1,2,3,4-tetrahydronaphth-1-ylamino]-6-(1- |
| | fluoro-1-methylethyl)-1,3,5-triazine |
| A-109 | 2-amino-4-[(1RS,2RS)-2,6-dimethyl-1,2,3,4-tetrahydronaphth-1-ylamino]- |
| | 6-(1-fluoro-1-methylethyl)-1,3,5-triazine |
| A-110 | 2-amino-4-[(1R,2S)-2,6-dimethyl-1,2,3,4-tetrahydronaphth-1-ylamino]-6- |
| | (1-fluoro-1-methylethyl)-1,3,5-triazine |
| A-111 | 2-amino-4-[(1RS,2R)-2,6-dimethyl-1,2,3,4-tetrahydronaphth-1-ylamino]-6- |
| | (1-fluoro-1-methylethyl)-1,3,5-triazine |
| A-112 | 2-amino-4-[(1RS)-6-methyl-1,2,3,4-tetrahydronaphth-1-ylamino]-6-(1- |
| | fluoro-1-methylethyl)-1,3,5-triazine |
| A-113 | 2-amino-4-[(1R)-6-methyl-1,2,3,4-tetrahydronaphth-1-ylamino]-6-(1- |
| | fluoro-1-methylethyl)-1,3,5-triazine |
| A-114 | 2-amino-4-[(1RS)-1,2,3,4-tetrahydronaphth-1-ylamino]-6-ethyl-1,3,5- |
| | triazine |
| A-115 | 2-amino-4-[(1R)-1,2,3,4-tetrahydronaphth-1-ylamino]-6-ethyl-1,3,5- |
| | triazine |
| A-116 | 2-amino-4-[(1RS)-6-methyl-1,2,3,4-tetrahydronaphth-1-ylamino]-6-ethyl- |
| | 1,3,5-triazine |
| A-117 | 2-amino-4-[(1R)-6-methyl-1,2,3,4-tetrahydronaphth-1-ylamino]-6-ethyl- |
| | 1,3,5-triazine |
| A-118 | 2-amino-4-[(1RS)-4,6-dimethyl-1,2,3,4-tetrahydronaphth-1-ylamino]-6- |
| | ethyl-1,3,5-triazine |
| A-119 | 2-amino-4-[(1R)-4,6-dimethyl-1,2,3,4-tertahydronaphth-1-ylamino]-6- |
| | ethyl-1,3,5-triazine |
| A-120 | 2-amino-4-[(1RS)-5-fluoro-6-methyl-1,2,3,4-tetrahydronaphth-1-ylamino]- |
| | 6-ethyl-1,3,5-triazine |
| A-121 | 2-amino-4-[(1R)-5-fluoro-6-methyl-1,2,3,4-tetrahydronaphth-1-ylamino]-6- |
| | ethyl-1,3,5-triazine |
| A-122 | 2-amino-4-[(1RS)-5-fluoro-6-methyl-1,2,3,4-tetrahydronaphth-1-ylamino]- |
| | 6-ethyl,1,3,5-triazine |
| A-123 | 2-amino-4-[(1R)-5-fluoro-6-methyl-1,2,3,4-tetrahydronaphth-1-ylamino]-6- |
| | ethyl-1,3,5-triazine |
| A-124 | 2-amino-4-[(1RS,2RS)-2,6-dimethyl-1,2,3,4-tetrahydronaphth-1-ylamino]- |
| | 6-ethyl-1,3,5-triazine |
| A-125 | 2-amino-4-[(1R,2S)-2,6-dimethyl-1,2,3,4-tetrahydronaphth-1-ylamino]-6- |
| | ethyl-1,3,5-triazine |
| A-126 | 2-amino-4-[(1R,2R)-2,6-dimethyl-1,2,3,4-tetrahydronaphth-1-ylamino]-6- |
| | ethyl-1,3,5-triazine |
| A-127 | 2-amino-4-[(1RS)-1,2,3,4-tetrahydronaphth-1-ylamino]-1,3,5-triazine |
| A-128 | 2-amino-4-[(1R)-1,2,3,4-tetrahydronaphth-1-ylamino]-1,3,5-triazine |
| A-129 | 2-amino-4-[(1RS,2RS)-2-methyl-1,2,3,4-tetrahydronaphth-1-ylamino]- |
| | 1,3,5-triazine |
| A-130 | 2-amino-4-[(1R,2S)-2-methyl-1,2,3,4-tetrahydronaphth-1-ylamino]-1,3,5- |
| | triazine |
| A-131 | 2-amino-4-[(1R,2R)-2-methyl-1,2,3,4-tetrahydronaphth-1-ylamino]-1,3,5- |
| | triazine |
| A-132 | 2-amino-4-[(1RS,2RS)-2,6-dimethyl-1,2,3,4-tetrahydronaphth-1-ylamino]- |
| | 1,3,5-triazine |
| A-133 | 2-amino-4-[(1R,2S)-2,6-dimethyl-1,2,3,4-tetrahydronaphth-1-ylamino]- |
| | 1,3,5-triazine |
| A-134 | 2-amino-4-[(1R,2R)-2,6-dimethyl-1,2,3,4-tetrahydronaphth-1-ylamino]- |
| | 1,3,5-triazine |
| A-135 | 2-amino-4-[(1RS)-5,6-dimethyl-1,2,3,4-tetrahydronaphth-1-ylamino]-1,3,5- |
| | triazine |
| A-136 | 2-amino-4-[(1R)-5,6-dimethyl-1,2,3,4-tetrahydronaphth-1-ylamino]-1,3,5- |
| | triazine |
| A-137 | 2-amino-4-[(1RS)-4,6-dimethyl-1,2,3,4-tetrahydronaphth-1-ylamino]-1,3,5- |
| | triazine |
| A-138 | 2-amino-4-[(1R)-4,6-dimethyl-1,2,3,4-tetrahydronaphth-1-ylamino]-1,3,5- |
| | triazine |
| A-139 | 2-amino-4-[(1RS)-5-fluoro-6-methyl-1,2,3,4-tetrahydronaphth-1-ylamino]- |
| | 1,3,5-triazine |
| A-140 | 2-amino-4-[(1R)-5-fluoro-6-methyl-1,2,3,4-tetrahydronaphth-1-ylamino]- |
| | 1,3,5-triazine |

Preference is also given to salts, preferably acid addition salts, of the compounds from table A, for example the hydrochlorides thereof.

The proportion of active substances (component 1) in the suspension concentrates according to the invention is preferably from 0.1 to 60% by weight, in particular from 0.5 to 55% by weight, furthermore preferably from 0.5 to 50% by weight, furthermore preferably from 1 to 50% by weight, furthermore preferably from 1 to 10% by weight or, with comparatively more highly effective substances, from 0.5 to 10% by weight, furthermore preferably from 1 to 5% by weight.

Examples of suitable derivatives, comprising phosphate groups, of the amino acids glycine/homoalanine (component 2) are compounds of the formulae (V) and (VI) mentioned below, i.e.

1. Compounds of the formula (V),

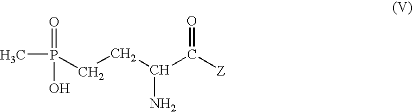

in which Z is a radical of the formula —OH or a peptide radical of the formula

—NHCH(CH₃)CONHCH(CH₃)COOH or

—NHCH(CH₃)CONHCH[CH₂CH(CH₃)₂]COOH, and the esters and salts thereof, preferably glufosinate and the salts thereof with acids and bases, in particular glufosinate-ammonium, L-glufosinate or the salts thereof, bialaphos and the salts thereof with acids and bases and other phosphinothricin derivatives.

The formula (V) includes all stereoisomers and the mixtures thereof, in particular the racemate and the enantiomer which is biologically effective in each case, e.g. L-glufosinate and the salts thereof.

Preferred examples of compounds of the formula (V) are:
(V.1) glufosinate in the relatively narrow sense, i.e. D,L-2-amino-4-[hydroxy(methyl)phosphinyl]butanoic acid,
(V.2) glufosinate monoammonium salt,
(V.3) L-glufosinate, L- or (2S)-2-amino-4-[hydroxy(methyl)phosphinyl]-butanoic acid (phosphinothricin),
(V.4) L-glufosinate monoammonium salt,
(V.5) bialaphos (or bilanafos), i.e. L-2-amino-4-[hydroxy(methyl)phosphinyl]-butanoyl-L-alanyl-L-alanine, in particular the sodium salt thereof.

The abovementioned compounds (V.1) to (V.5) are taken up via the green parts of the plants and are well known as broad-spectrum herbicides or total herbicides; they are inhibitors of the enzyme glutamine synthetase in plants (see “The Pesticide Manual”, 11th edition, British Crop Protection Council 1997, pp. 643-645 or 120-121). While one field of use consists in the postemergence method for the combating of weeds, including grass weeds, in plantation crops and on non-crop areas and also, by means of special application techniques, for inter-row combating in agricultural surface crops, such as corn, cotton, inter alia, the importance of the use as selective herbicide in tolerant or resistant transgenic plant crops is increasing. Glufosinate is generally used in the form of a salt, preferably of the ammonium salt. The racemate of glufosinate or glufosinate-ammonium is normally applied alone in dosages lying between 50 and 2000 g of active substance per hectare. In these dosages, glufosinate is then effective in particular if it is taken up via green plant parts. Since it is microbially decomposed in the soil within a few days, it has no lasting effect in the soil. A similar situation also applies for the active substance bialaphos-sodium used (bialaphos-sodium is also known as bilanofos-sodium; see “The Pesticide Manual”, 11th ed., British Crop Protection Council, 1997, pp. 120-121).

2. Compounds of the formula (VI) and the esters and salts thereof,

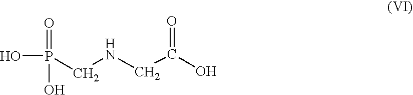

preferably glyphosate and the alkali metal salts thereof or salts thereof with amines, in particular glyphosate-isopropylammonium, and sulfosate.

Preferred examples of compounds of the formula (VI) are:
(VI.1) glyphosate, i.e. N-(phosphonomethyl)glycine,
(VI.2) glyphosate monoisopropylammonium salt,
(VI.3) glyphosate sodium salt,
(VI.4) sulfosate, i.e. N-(phosphonomethyl)glycine trimesium salt =N-(phosphonomethyl)glycine trimethylsulfoxonium salt.

Glyphosate is normally used in the form of a salt, preferably of the monoisopropylammonium salt or of the trimethylsulfoxonium salt(=trimesium salt=sulfosate). The individual dosage ranges from 0.050 to 5 kg of active substance per hectare, based on the free acid glyphosate. Glyphosate is similar to glufosinate with regard to many performance aspects; however, it is, in contrast to glufosinate, an inhibitor of the enzyme 5-enolpyruvylshikimate-3-phosphate synthase in plants (see “The Pesticide Manual”, 11th ed., British Crop Protection Council, 1997, pp. 646-649). Here also, the importance of the use as selective herbicide in tolerant or resistant transgenic plant crops is increasing.

The compounds of the formulae (V) and (VI) are known or can be prepared analogously to known methods.

The proportion of active substances (component 2) in the suspension concentrates according to the invention is preferably from 0.1 to 65% by weight, in particular from 0.2 to 50% by weight, furthermore preferably from 1 to 45% by weight, furthermore preferably from 5 to 30% by weight.

In individual cases, it may be useful to combine one or more of the compounds of the component (1) with several compounds of the component (2), this also applying in reverse order.

Furthermore, the combinations according to the invention can be used together with other active substances, for example from the group consisting of the safeners, fungicides, insecticides and plant growth regulators or from the group consisting of the additives conventional in plant protection, such as, for example, fertilizers and colorants.

Likewise, yet further additional active substances from the group consisting of the herbicides can also be added, however, such as are described, for example, in “The Pesticide Manual”, 13th edition, British Crop Protection Council, 2005), such as, e.g., Mecoprop (Number 503).

The surfactants (component 3) based on non-salt-like substituted phenol ethers are, for example, nonionic mono-, di- or, preferably, trisubstituted phenols which can be alkoxylated, e.g. ethoxylated and/or propoxylated and/or butoxylated. In this connection, the number of the alkyleneoxy units ranges, for example, from 1 to 100, preferably 3 to 60, particularly preferably 5 to 25. Substituents on the phenol ring of the phenol derivatives are preferably styryl or isoalkyl radicals. In this connection, the term “styryl radical” describes the radical which is produced by aromatic substitution of the phenol by styrene, i.e. a “1-phenylethyl radical”. Examples are phenyl(C₁-C₄)alkyl ethers or (poly)alkoxylated phenols[=phenol(poly)alkylene glycol ethers], for example with 1 to 50 alkyleneoxy units in the (poly)alkyleneoxy part, the alkylene part preferably exhibiting 2 to 4 carbon atoms each time, preferably phenol reacted with 3 to 10 mol of alkylene oxide, (poly)alkylphenols or (poly)alkylphenol alkoxylates[=polyalkylphenol(poly)alkylene glycol ethers], for example with 1 to 12 carbon atoms per alkyl radical and 1 to 150 alkyleneoxy units in the polyalkyleneoxy part, preferably tri(n-butyl)phenol or triisobutylphenol reacted with 1 to 50 mol of ethylene oxide, polyarylphenols or polyarylphenol alkoxylates[=polyarylphenol(poly)alkylene glycol ethers], for example tristyrylphenol polyalkylene glycol ethers with 1 to 150 alkyleneoxy units in the polyalkyleneoxy part, preferably tristyrylphenol reacted with 1 to 50 mol of ethylene oxide(=tristyrylphenol with 1 to 50 EO=ethyleneoxy units).

The nonionic surfactants mentioned can also be modified with functional groups, for example be phosphated or sulfated. However, they must then be used as component (3) in their acid form and not in the neutralized salt form. In this connection, the formation of salts of the lastmentioned surfactants with additional suitable basic components of the formulation is not excluded; however, it is generally not preferred. In addition, phosphated or sulfated nonionic surfactants in which the phosphoric acid or sulfate groups are completely esterified are likewise possible.

Preference is given to tri[(C₁-C₄)alkyl]phenol alkoxylates with 1 to 30 EO or tristyrylphenol alkoxylates with 10 to 30 EO. Correspondingly phosphated surfactants in the non-salt-like (acid) form are likewise preferably suitable.

Examples of surfactants of the component (3) are Soprophor® 3D33 (=tristyryl-phenol, ethoxylated with 16 EO and phosphated), Soprophor® BSU (=tristyrylphenol, ethoxylated with 16 EO), Soprophor® CY/8 (Rhodia) (=tristyrylphenol, ethoxylated with 20 EO) and Hoe® S3474 (=tristyrylphenol, ethoxylated with 20 EO), and in the form of the Sapogenat® T products (Clariant), for example Sapogenat® T 100 (=tri-isobutylphenol, ethoxylated with 10 EO).

Examples of nonionic surfactants of the component (3) are also phenol reacted with 4 to 10 mol of ethylene oxide, available commercially, for example, in the form of the Agrisol® products (Akcros), and nonylphenol reacted with 4 to 50 mol of ethylene oxide, available commercially, for example, in the form of the Arkopal® products (Clariant).

Examples of non-salt-like surfactants of the component (3) are the acidic phosphoric esters of tristyrylphenol reacted with 1 to 50 mol of ethylene oxide, such as Soprophor® 3D33 or Soprophor® 4D-384 (Rhodia).

Mixtures of several surfactants from the group consisting of the non-salt-like substituted phenol ethers are also preferred for the component (3).

Preference is given in this connection to mixtures of two or more of the abovementioned nonionic surfactants of the component (3); mixtures of one or more of the abovementioned nonionic surfactants and one or more of the abovementioned non-salt-like (acidic) phosphated surfactants of the component (3) are also preferred.

Preference is given to mixtures of two or more surfactants of the component (3) which differ in the number of the units in the polyoxyalkylene chain, preferably in 2 to 10 units.

The proportion of surfactants of the component (3) in the suspension concentrates according to the invention is generally from 0.01 to 20% by weight, preferably from 0.05 to 10% by weight, furthermore preferably from 0.1 to 10% by weight, particularly preferably from 0.1 to 7% by weight or even from 1 to 7% by weight.

Possible thickeners (component 4) are generally all thickeners used in or suitable for plant protection compositions, for example inorganic (mineral) thickeners, such as thickeners based on aluminum silicate, or thickeners of another type, such as organic thickeners, for example agar, carrageenan, gum tragacanth, gum arabic, alginates, pectins, polysaccharides, guar flour, locust bean flour, starch, dextrins, cellulose ethers, such as carboxymethylcellulose and hydroxyethycellulose, polyacrylic and polymethacrylic compounds, vinyl polymers, polyethers or polyamides.

Possible thickeners (component 4) based on aluminum silicate are, for example, those such as hectorites, montmorillonites, saponites, kaolinites, bentonites, attapulgites, and the like.

Examples of such thickeners are the Attagels® from Engelhardt Corp, e.g. Attagel 50, a hydrous magnesium aluminum silicate (attapulgite), or the Bentone® series from Elementis, such as Bentone EW, a hydrous magnesium aluminum silicate (bentonite).

Examples of preferred organic thickeners are xanthans (heteropolysaccharides), such as the Rhodopol® products from Rhodia, e.g. Rhodopol 50 MC (xanthan gum) or Rhodopol 23 (a xanthan heteropolysaccharide).

The thickeners can also be used in combination. In this connection, combinations of organic and mineral thickeners may also be suitable.

The suitable proportion of thickeners depends on the viscosity of the formulation and on the individual thickeners and is generally, for example, from 0.001 to 10% by weight, preferably from 0.005 to 5% by weight, based on the weight of the formulation. The proportion of thickeners based on aluminum silicate in the suspension concentrates according to the invention is preferably from 0.01 to 5% by weight, preferably from 0.1 to 3.5% by weight. With thickeners of xanthan type, the proportion is preferably from 0.001 to 5% by weight, in particular from 0.005 to 1% by weight.

In addition, yet further formulation auxiliaries (component 5), such as antifoaming agents, antifreeze agents, preservatives, colorants or fertilizers, and also surfactants other than component (3) (component 6) can be added to these formulations.

The proportion of these formulation auxiliaries (component 5) in the suspension concentrates according to the invention is preferably from 0.1 to 22% by weight, in particular from 0.5 to 18% by weight, furthermore preferably from 1 to 15% by weight.

Possible antifoaming agents are silicone-based antifoaming agents from Wacker, Rhodia or Dow Corning and acetylene-based antifoaming agents, such as, for example, from Air Products. Typical representatives of suitable antifoaming agents are, inter alia, Rhodorsil® Silcolapse 5020 (O/W polydimethylsiloxane emulsion) and Rhodorsil® 481 (mixture of polydimethylsiloxane and silicon) from Rhodia.

Possible antifreeze agents are, for example, glycol, propylene glycol, glycerol and urea.

Possible preservatives are standard biocidal compounds, for example Acticide® MBS (mixture of 1,2-benzothiazol-3(2H)-one and 2-methyl-2H-isothiazol-3-one (Thor).

Examples of additional surfactants other than component (3) (component 6) are listed below, in which EO=ethylene oxide units, PO=propylene oxide units and BO=butylene oxide units:
1) C₁₀-C₂₄-Alcohols, which can be alkoxylated, e.g., with 1-60 alkylene oxide units, preferably 1-60 EO and/or 1-30 PO and/or 1-15 BO, in any sequence. The terminal hydroxyl groups of these compounds can be end group closed by an alkyl, cycloalkyl or acyl radical with 1-24 carbon atoms. Examples of such compounds are:
Genapol® C, L, O, T, UD, UDD, X products from Clariant, Plurafac® and Lutensol® A, AT, ON, TO products from BASF, Marlipal® b 24 and O13 products from Condea, Dehypon® products from Henkel, Ethylan® products from Akzo-Nobel, such as Ethylan CD 120.
2) Anionic derivatives of the products described under 1) in the form of ether carboxylates, sulfonates, sulfates and phosphates and the inorganic (e.g., alkali metal and alkaline earth metal) and organic (e.g., amine- or alkanolamine-based) salts thereof, such as Genapol® LRO, Sandopan® products, Hostaphat/Hordaphos® products from Clariant.
Copolymers consisting of EO, PO and/or BO units, such as, for example, block copolymers, such as the Pluronic® products from BASF and the Synperonic® products from Uniquema, with a molecular weight of 400 to 10⁸. Alkylene oxide adducts of C₁-C₉-alcohols, such as Atlox® 5000 from Uniquema or Hoe® S3510 from Clariant.
Typical additional representatives are, inter alia, also Galoryl® MT 804 (dibutylnaphthalenesulfonate sodium salt) from Nufam, Geropon® T 36 (sodium polycarboxylic acid), Supragil® MNS 90 (methylnaphthalenesulfonic acid sodium salt condensation product) from Rhodia and Darvan® No. 3 (sodium salt of polymerized arylalkyl sulfonic acids) from Vanderbilt, which can be used as dispersants, and Geronol® CF/AR (ammonium salt of phosphate esters of ethoxylated alcohols) and Supragil® WP (sodium diisopropylnaphthalenesulfonate) from Rhodia, which can be used as wetting agents.
3) Fatty acid and triglyceride alkoxylates, such as the Serdox® NOG products from Condea or alkoxylated vegetable oils, such as soybean oil, rapeseed oil, corn oil, sunflower oil, cottonseed oil, linseed oil, coconut oil, palm oil, thistle oil, walnut oil, peanut oil, olive oil or castor oil, in particular rapeseed oil, the term “vegetable oils” also being understood as meaning the transesterification products thereof, e.g. alkyl esters, such as rapeseed oil methyl ester or rapeseed oil ethyl ester, for example the Emulsogen® products from Clariant, salts of aliphatic, cycloaliphatic and olefinic carboxylic acids and polycarboxylic acids, and α-sulfofatty acid esters, as available from Henkel.
4) Fatty acid amide alkoxylates, such as the Comperlan® products from Henkel or the Amam® products from Rhodia.
Alkyleneoxy adducts of alkynediols, such as the Surfynol® products from Air Products. Sugar derivatives, such as amino- and amidosugars from Clariant, glucitols from Clariant, alkylpolyglycosides in the form of the APG® products from Henkel or such as sorbitan esters in the form of the Span® or Tween® products from Uniquema or cyclodextrin esters or ethers from Wacker. A typical representative here is, inter alia, also Atplus® 435 (alkylpolyglycoside/alkylpolysaccharide mixture) from ICI, which, for example, can be used as wetting agent.
5) Surface-active cellulose and algin, pectin and guar derivatives, such as the Tylose® products from Clariant, the Manutex® products from Kelco and guar derivatives from Cesalpina.
Alkylene oxide adducts based on polyols, such as the Polyglykol® products from Clariant. Surface-active polyglycerides and the derivatives thereof from Clariant.
6) Sulfosuccinates, alkanesulfonates, paraffinsulfonates and olefinsulfonates, such as Netzer IS®, Hoe® S1728, Hostapur® OS, Hostapur® SAS from Clariant, Triton® GR7ME and GR5 from Union Carbide, Empimin® products from Albright and Wilson, Marlon® PS65 from Condea.
7) Sulfosuccinamates, such as the Aerosol® products from Cytec or the Empimin® products from Albright and Wilson.
8) Alkylene oxide adducts of fatty amines, quaternary ammonium compounds with 8 to 22 carbon atoms (C₈-C₂₂), such as, e.g., the Genamin® C, L, O, T products from Clariant.
9) Surface-active zwitterionic compounds, such as taurides, betaines and sulfobetaines in the form of Tegotain® products from Goldschmidt, Hostapon® T and Arkopon® T products from Clariant.
10) Surface-active compounds based on silicones or silanes, such as the Tegopren® products from Goldschmidt and the SE® products from Wacker, and also the Bevaloid®, Rhodorsil® and Silcolapse® products from Rhodia (Dow Corning, Reliance, GE, Bayer).
11) Per- or polyfluorinated surface-active compounds, such as the Fluowet® products from Clariant, the Bayowet® products from Bayer, the Zonyl® products from DuPont and products of this type from Daikin and Asahi Glass.
12) Surface-active sulfonamides, e.g. from Bayer.
13) Surface-active polyacrylic and polymethacrylic derivatives, such as the Sokalan® products from BASF.
14) Surface-active polyamides, such as modified gelatin or derivatized polyaspartic acid from Bayer and the derivatives thereof.
15) Surface-active polyvinyl compounds, such as modified polyvinylpyrrolidone, such as the Luviskol® products from BASF and the Agrimer® products from ISP, or derivatized polyvinyl acetates, such as the Mowilith® products from Clariant, or polyvinyl butyrates, such as the Lutonal® products from BASF, the Vinnapas® and the Pioloform® products from Wacker, or modified polyvinyl alcohols, such as the Mowiol® products from Clariant.
16) Surface-active polymers based on maleic anhydride and/or reaction products of maleic anhydride, and also copolymers comprising maleic anhydride and/or reaction products of maleic anhydride, such as the Agrimer® VEMA products from ISP.
17) Surface-active derivatives of montan, polyethylene and polypropylene waxes, such as the Hoechst® waxes or the Licowet® products from Clariant.
18) Surface-active phosphonates and phosphinates, such as Fluowet® PL from Clariant.
19) Poly- or perhalogenated surfactants, such as, for example, Emulsogen® 1557 from Clariant.
20) Anionic compounds which are formally the reaction products of the abovementioned phenols of the component (3) with sulfuric acid or phosphoric acid and are neutralized with suitable bases (salts), for example the acidic phosphoric ester, neutralized with NaOH, of triethoxylated phenol, the acidic phosphoric ester, neutralized with NaOH, of a nonylphenol reacted with 9 mol of ethylene oxide and the phosphoric ester, neutralized with triethanolamine, of the reaction product of 20 mol of ethylene oxide and 1 mol of tristyrylphenol.
21) Benzenesulfonates, such as alkyl- or arylbenzenesulfonates, e.g. (poly)alkyl- and (poly)arylbenzenesulfonic which are in the acid form or neutralized with suitable bases, for example having 1 to 12 carbon atoms per alkyl radical or having up to 3 styrene units in the polyaryl radical, preferably (linear) dodecylbenzenesulfonic acid or the oil-soluble salts thereof, such as, for example, the calcium salt or the isopropylammonium salt of dodecylbenzene-sulfonic acid. Examples of such surfactants are the acidic (linear) dodecylbenzenesulfonate, commercially available, for example, in the form of Marlon® products (Hüls), or calcium dodecylbenzenesulfonate.

1,2-Ethyleneoxy, 1,2-propyleneoxy, 1,2-butyleneoxy and 2,3-butyleneoxy units, in particular 1,2-ethyleneoxy units, are preferred for the alkyleneoxy units.

Examples of surfactants from the group consisting of the nonaromatic-based surfactants are the surfactants of the abovementioned groups 1) to 19), preferably of the groups 1), 2), 6) and 8).

Examples of surfactants from the group consisting of the aromatic-based surfactants are the surfactants of the abovementioned groups 20) and 21), preferably the neutralized phosphoric ester of tristyrylphenol reacted with 1 to 50 mol of ethylene oxide, for example from the Soprophor® series (Rhodia), such as Soprophor® FL.

The proportion of surfactants of the component (6) is preferably from 0 to 60% by weight, in particular from 1 to 50% by weight, furthermore preferably from 10 to 40% by weight of surfactant, based on the weight of the formulation. The amounts indicated for the surfactants refer, in the cases of the components (6) and also (3), each time to the weight of the detergent substance (without water content).

Preferred suspension concentrates comprise the components (1) to (6) in the amounts in which individual or several components are present in the amounts given preferably therefor.

The suspension concentrates according to the invention can be prepared in a known way (see Winnacker-Küchler, “Chemische Technologie [Chemical Technology]”, Volume 7, C. Hanser Verlag, Munich, 4th edition, 1986), e.g. by wet milling the components, which can take place in suitable mills, e.g. in bead mills (such as, e.g., bead mills operating batchwise, e.g. from Drais, or bead mills operating continuously, e.g. from Bachofen) or colloid mills (such as, e.g., toothed colloid mills, e.g. from Probst+Claasen).

In a preferred embodiment of the invention, milling is carried out until 50% of the particles of the formulation exhibit a size of less than or equal to 4 μm (d50≦4 μm).

Preferably, in this connection, the active substances (component 1) in the formulation exhibit a particle size of d50 less than or equal to 4 μm; in particular, 60% or very particularly 80% of the active substance particles exhibit a particle size ranging from 1 to 4 μm.

The invention furthermore relates to compositions which can be obtained from the suspension concentrate according to the invention by diluting with liquids, preferably water.

It can be advantageous to treat the compositions thus obtained with additional active substances, preferably agrochemical active substances (e.g., as tank mix partners in the form of appropriate formulations) and/or auxiliaries and additives standard in the application, e.g. self-emulsifying oils, such as vegetable oils or paraffin oils, and/or fertilizers. The present invention also accordingly relates to those compositions, preferably herbicidal compositions, based on the suspension concentrates according to the invention.

In this connection, the term “agrochemical active substances” embraces all substances which are used in the agricultural, horticultural, forestry and animal husbandry fields, and also in the domestic sphere and in stockpiling. These agrochemical active substances include, for example, herbicides, insecticides, acaricides, rodenticides, fungicides, bactericides, nematicides, algicides, molluscicides, viricides, safeners, active substances which induce resistance to plant damage, active substances effective as repellents and active substances effective as growth regulators, active substances with and from biological organisms, and fertilizers. Particular preference is given to active substances effective as herbicides, insecticides, acaricides, fungicides, bactericides, viricides and growth regulators or as safeners. Very particular preference is given to herbicides, insecticides, fungicides and safeners and, in turn, among them, herbicidal active substances are preferred.

A particular embodiment of the invention relates to the use of the compositions obtainable from the suspension concentrates according to the invention for combating undesirable plant growth, described subsequently as “herbicidal compositions”.

The herbicidal compositions exhibit an outstanding herbicidal activity against a broad spectrum of economically important harmful monocotyledonous and dicotyledonous plants. Even perennial weeds which sprout from rhizomes, root stocks or other perennial organs and which are difficult to combat are successfully included. In this connection, the herbicidal compositions can be applied, e.g., in the presowing, preemergence or postemergence method. Specifically, mention may be made, by way of example, of some representatives of the mono- and dicotyledonous weed flora which can be controlled by the herbicidal compositions, without the designation resulting in a limitation to certain species.

In the case of the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and also Bromus spp., such as Bromus catharticus, Bromus secalinus, Bromus erectus, Bromus tectorum and Bromus japonicus, and Cyperus species from the group of the annuals and, in the case of the perennial species, Agropyron, Cynodon, Imperata and also Sorghum and even perennial Cyperus species, e.g., are successfully included.

With dicotyledonous weed species, the spectrum of activity applies to species such as, e.g., Abutilon spp., Amaranthus spp., Chenopodium spp., Chrysanthemum spp., Galium spp., such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., in the case of the annuals, and Convolvulus, Cirsium, Rumex and Artemisia with the perennial weeds.

Harmful plants occurring under the specific cultivation conditions in rice, such as, e.g., Echinochloa, Sagittaria, Alisma, Eleocharis, Scirpus and Cyperus, are likewise combated in an outstanding fashion by the herbicidal compositions.

If the herbicidal compositions are applied to the soil surface before germination, then either the emergence of the weed seedlings is completely prevented or the weeds grow until they have reached the cotyledon stage but then their growth ceases and finally, after 3 to 4 weeks have elapsed, they completely die.

On application of the herbicidal compositions to the green parts of the plants in the postemergence method, a drastic halt in growth likewise occurs very quickly after the treatment and the weed plants stay in the growth stage present at the time of application or completely die after a certain time, so that in this way competition by weeds, which is harmful for the crop plants, is eliminated very early and with lasting effect.

The herbicidal compositions are distinguished by a rapidly commencing and longlasting herbicidal action. The resistance to rain of the active substances in the herbicidal compositions is generally good. A particular advantage is crucially that the dosages of herbicidal compounds which are used in the herbicidal compositions and which are effective can be adjusted to such a low value that their soil action is optimally low. Accordingly, not only is their use finally possible in sensitive crops but groundwater contamination is virtually avoided. A substantial reduction in the amount of the active substances which has to be expended is made possible by the active substance combination according to the invention.

The properties and advantages mentioned are of use in the practical combating of weeds in order to keep agricultural crops free from undesirable competing plants and accordingly to safeguard and/or to increase the yields in terms of quality and quantity. The technical standard is, with regard to the properties described, clearly exceeded by these new herbicidal compositions.

Although the herbicidal compositions exhibit an outstanding herbicidal activity with regard to mono- and dicotyledonous weeds, crop plants of economically important crops, e.g. dicotyledonous crops, such as soya, cotton, rape, sugar beet, or gramineous crops, such as wheat, barley, rye, oats, millet, rice or corn, or preferably plantation crops, are undamaged or only insignificantly damaged insofar as they have tolerance or resistance, acquired naturally or transgenically, with regard to the herbicides present in the herbicidal composition. The present herbicidal compositions, for these reasons, are very well suited to the selective combating of undesirable plant growth in agriculturally useful plants or in ornamental plants.

In addition, the corresponding herbicidal compositions exhibit outstanding growth-regulatory properties depending on crop plant. They intervene in a regulatory manner in the plants' metabolism and can accordingly be used for the selective influencing of plant contents and for making it easier to harvest, such as, e.g., by controlling desiccation and stunted growth. Furthermore, they are also potentially suitable for the general control and inhibition of undesirable vegetative growth, without in this connection killing the plants. Inhibition of vegetative growth plays a major role in many mono- and dicotyledonous crops since lodging can be reduced or completely prevented through this.

Because of their herbicidal and plant-growth-regulatory properties, the herbicidal compositions, as already mentioned, can also be used for combating harmful plants in crops of known genetically modified plants or genetically modified plants still to be developed. The transgenic plants are generally distinguished by particular advantageous properties, for example by resistance to certain pesticides, mainly certain herbicides, resistance to plant diseases or causative agents of plant diseases, such as certain insects or microorganisms, such as fungi, bacteria or viruses. Other particular properties relate, e.g., to the harvested crops with regard to amount, quality, storability, composition and special ingredients. Thus, transgenic plants with increased starch content or modified quality of the starch or those with a different fatty acid composition of the harvested crops are known.

Preference is given to the use of the herbicidal compositions in economically important transgenic crops of useful and ornamental plants, e.g. of gramineous crops, such as wheat, barley, rye, oats, millet, rice and corn, or also crops of sugar beet, cotton, soya, rape, potato, tomato, peas and other kinds of vegetable. Preferably, the herbicidal compositions can be used in crops of useful plants which are resistant to the phytotoxic effects of the herbicides or which have been made resistant by genetic engineering.

When the herbicidal compositions are used in transgenic crops, effects often occur, in addition to the effects with regard to harmful plants to be observed in other crops, which are specific for the application in the respective transgenic crop, for example a modified or specially broadened weed spectrum which can be combated, modified amounts to be expended which can be used for the application, preferably good ability to be combined with the additional herbicidal active substances to which the transgenic crop is resistant, and influencing of growth and yield of the transgenic crop plants.

Another subject matter of the present invention is accordingly a process for combating undesirable plant growth, preferably in crop plants, such as cereals (e.g., wheat, barley, rye, oats, rice, corn, millet), sugar beet, sugar cane, rape, cotton and soya, particularly preferably in monocotyledonous crops, such as cereals, e.g. wheat, barley, rye, oats, hybrids thereof, such as triticale, rice, corn and millet, wherein the herbicidal compositions according to the invention are applied to the harmful plants, plant parts, plant seeds or the area on which the plants are growing, e.g. the area under cultivation.

Another subject matter of the invention is a process for combating undesirable plant growth in plantation crops, wherein the herbicidal compositions according to the invention are applied to the harmful plants, plant parts, plant seeds or the area on which the plants are growing, e.g. the area under cultivation.

The crop plants can also be modified by genetic engineering or obtained by mutation selection and are preferably tolerant to acetolactate synthase (ALS) inhibitors (see, e.g., EP-A-0 257 993, U.S. Pat. No. 5,013,699) or glyphosate herbicides (see WO 92/00377) or glufosinate herbicides (see EP-A-0 242 236, EP-A-242 246).

With the suspension concentrates according to the invention, a better biological action can be achieved for the same amount expended.

In addition, the suspension concentrates according to the invention have additional advantages as special active substance combination formulations (synonym: mixed formulations, coformulations), such as, e.g., a lower consumption of packaging material than when the individual active substances are used, through which the cost of preparation, transportation and storage is reduced and the formulating of the spray mixtures used in agriculture can be better handled through the smaller amounts and the preadjusted effective ratios of quantities, such as, e.g., in the measuring and mixing operation.

The suspension concentrates according to the invention additionally display, surprisingly, excellent dispersing and stabilizing properties after further diluting with liquids, preferably water.

In addition, the suspension concentrates according to the invention produce formulations which are stable on storage over a long time and which perform perfectly.

The invention is more fully explained by the examples, without thereby limiting it.

### EXAMPLES

1. Preparation:

Water is placed in a vessel and circulated by pumping through a colloid mill. Thickeners (e.g., Bentone®; Rhodopol®) and optionally formulation auxiliaries, such as, for example, antifoaming agents (e.g., Rhodorsil®) and/or antifreeze agents (e.g., propylene glycol), are added, followed by the surfactants (e.g., Soprophor®, Genapol®, Geronol®, Geropon®, Galoryl®, Supragil®, Darvan®, Atplus®). The active substances are added as final components. The combined mixture is then transferred via the colloid mill into an additional vessel. This mixture is then milled by wet milling using bead mills.

2. Compositions:

TABLE I
Formulation examples Nos. 1–10

| Example No./Component: | | 1 | 2 | 3 | 4 | 5 | 6 | 7 | 8 | 9 | 10 |
|---|---|---|---|---|---|---|---|---|---|---|---|
| 1 | Active substance A*) | 2.72 | 1.3 | 2.12 | 1.3 | 0.7 | 2.27 | 3.35 | 2.3 | 2.3 | 4.54 |
| 2 | Active substance V.2 | | | | | | 13.7 | 20.1 | 14 | 11.9 | 26.75 |
| 2 | Active substance VI.2 | 18.78 | 19.57 | 18.5 | 19.55 | 22.87 | | | | | |
| — | Additional active | | | | | | | | | | 3 |
| | substance**) | | | | | | | | | | |
| 3 | Soprophor ® 3D33 | 0.065 | 0.032 | 0.06 | 0.014 | 0.01 | 0.055 | 0.08 | 0.055 | 0.056 | 0.12 |
| 3 | Soprophor ® CY/8 | 0.03 | 0.015 | 0.03 | 0.015 | 0.01 | 0.025 | 0.04 | 0.027 | 0.026 | 0.065 |
| 3 | Soprophor ® BSU | 0.12 | 0.06 | 0.12 | 0.06 | 0.03 | 0.105 | 0.16 | 0.11 | 0.1 | 0.15 |
| 4 | Rhodopol ® 50 MC | | | | | | 0.005 | 0.006 | 0.005 | 0.005 | 0.008 |
| 4 | Bentone ® EW | 0.05 | 0.06 | 0.05 | 0.05 | 0.07 | | | | | |
| 5 | Propylene glycol | 2 | 2 | 3 | 2 | 4 | 8 | 12 | 8 | 9 | 9 |
| 5 | Rhodorsil ® Silcolapse 5020 | 1 | 1 | 1 | 1 | 0.8 | 0.5 | 0.5 | 0.5 | 0.5 | 0.5 |
| 6 | Genapol ® LRO***) | | | | | | 50 | 40 | 50 | 47 | 43 |
| 6 | Geronol ® CF/AR****) | 25 | 23 | 20 | 25 | 22 | | | | | |
| 6 | Galoryl ® MT 804 | 2 | 2 | 3 | 2 | 3 | 2 | 2 | 2 | 2.5 | 2.3 |
| | Water | to 100 | to 100 | to 100 | to 100 | to 100 | to 100 | to 100 | to 100 | to 100 | to 100 |

All specifications in % by weight;
*)active substance A (component 1): compound from table A (A-1 to A-140),
**)additional active sudstance: mecoprop (as potassium salt; see Number 503 in “The Pesticide Manual”, 13th edition, British Crop Protection Council, 2005),
***)Genapol ® LRO = 70% aqueous paste of sodium (C₁₂–C₁₄)fatty alcohol diethylene glycol ether sulfate,
****)Geronol ® CF/AR = 70% aqueous solution of ammonium fatty alcohol ethoxylate phosphate

TABLE II
Formulation examples Nos. 11–20

| Example No./Component: | | 11 | 12 | 13 | 14 | 15 | 16 | 17 | 18 | 19 | 20 |
|---|---|---|---|---|---|---|---|---|---|---|---|
| 1 | Active substance A*) | 2.72 | 1.3 | 2.12 | 1.3 | 0.7 | 2.27 | 3.35 | 2.3 | 2.3 | 4.54 |
| 2 | Active substance V.2 | | | | | | 13.7 | 20.1 | 14 | 11.9 | 26.75 |
| 2 | Active substance VI.2 | 18.76 | 19.57 | 18.5 | 19.55 | 22.87 | | | | | |
| 3 | Soprophor ® 3D33 | 0.065 | 0.032 | 0.06 | 0.014 | 0.01 | 0.055 | 0.08 | 0.055 | 0.056 | 0.12 |
| 3 | Soprophor ® CY/8 | 0.03 | 0.015 | 0.03 | 0.015 | 0.01 | 0.025 | 0.04 | 0.027 | 0.026 | 0.065 |
| 3 | Soprophor ® BSU | 0.12 | 0.06 | 0.12 | 0.06 | 0.03 | 0.105 | 0.16 | 0.11 | 0.1 | 0.15 |
| 4 | Bentone ® EW | 0.05 | 0.06 | 0.05 | 0.05 | 0.07 | | | | | |
| 4 | Rhodopol ® 50 MC | | | | | | 0.005 | 0.005 | 0.005 | 0.005 | 0.008 |
| 5 | Propylene glycol | 2 | 2 | 3 | 2 | 4 | 8 | 12 | 8 | 9 | 3 |
| 5 | Rhodorsil ® Silcolapse 5020 | 1 | 1 | 1 | 1 | 0.8 | 0.5 | 0.5 | 0.5 | 0.5 | 0.5 |
| 6 | Genapol ® LRO***) | | | | | | 50 | 40 | 50 | 47 | 43 |
| 6 | Genapol ® X 150 | | | | | | 2 | | | | |
| 6 | Geronol ® CF/AR****) | 25 | 23 | 20 | 25 | 22 | | | | | |
| 6 | Geropon ® T 36 | 2 | | | | | | | | | 2.3 |
| 6 | Supragil ® MNS 90 | | 2 | | | | | | | 2.5 | |
| 6 | Supragil ® WP | | | 3 | | | | | 2 | | |
| 6 | Darvan ® No 3 | | | | 2 | | | | | | |
| 6 | Atplus ® 435 | | | | | 4 | | 2 | | | |
| | Water | to 100 | to 100 | to 100 | to 100 | to 100 | to 100 | to 100 | to 100 | to 100 | to 100 |

All specifications in % by weight;
for the explanation of *), ***), ****), see table I

3. Experimental Study of the Storage Stability

The test formulations were stored for 8 weeks at 40° C. and were then tested for their consistency. The formulations were stable over the period of time.

4. Biological Comparative Tests

The suspension concentrates according to the invention bring about a markedly improved biological action with the same application dosage compared with standard formulations of the state of the art, such as wettable powders (WP), water-soluble powders (SP), capsule suspensions (CS), dustable powders (DP), granules for broadcasting and soil application, granules (GR) in the form of microgranules, spray granules, coated granules and adsorption granules.

In addition, it can be ascertained that an average relatively low particle size of less than 4 μm results in an additional increase in effectiveness with the suspension concentrates according to the invention.

What is claimed is:

1. An aqueous suspension concentrate which comprises
(1) one or more active substances from the group consisting of herbicidally effective 2,4-diamino-s-triazines which are N-substituted on an amino group with a (hetero)aryl(hetero)alkyl group,
(2) one or more active substances from the group consisting of herbicidally effective derivatives, comprising phosphate groups, of the amino acids glycine/homoalanine,
(3) one or more surfactants based on non-salt-like substituted phenol ethers,
(4) one or more thickeners.

2. The suspension concentrate as claimed in claim 1, which additionally comprises additional formulation auxiliaries (component 5).

3. The suspension concentrate as claimed in claim 1, which additionally comprises surfactants other than component (3) (component 6).

4. The suspension concentrate as claimed in claim 1, which additionally comprises additional formulation auxiliaries (component 5) and additionally comprises surfactants other than component (3) (component 6).

5. The suspension concentrate as claimed in claim 1, which comprises one or more thickeners based on aluminum silicate.

6. The suspension concentrate as claimed in claim 2, which comprises one or more thickeners based on aluminum silicate.

7. The suspension concentrate as claimed in claim 3, which comprises one or more thickeners based on aluminum silicate.

8. The suspension concentrate as claimed in claim 4, which comprises one or more thickeners based on aluminum silicate.

9. A process for the preparation of a suspension concentrate as claimed in claim 1, which comprises the wet milling of the components.

10. A composition which can be obtained from a suspension concentrate as claimed in claim 1 by diluting with liquids, preferably water.

11. A method for combating undesirable plant growth which comprises applying a suspension concentrate as claimed in claim 1 optionally after dilution with water to the harmful plants, plant parts, plant seed or the area where the plants are growing.

12. The method as claimed in claim 11 wherein the suspension concentrate additionally comprises additional formulation auxiliaries (component 5).

13. The method as claimed in claim 11 wherein the suspension concentrate additionally comprises surfactants other than component (3) (component 6).

14. The method as claimed in claim 11 wherein the suspension concentrate additionally comprises additional formulation auxiliaries (component 5) and surfactants other than component (3) (component 6).

15. The method as claimed in claim 11 wherein the suspension concentrate comprises one or more thickeners based on aluminium silicate.

16. The method as claimed in claim 12 wherein the suspension concentrate comprises one or more thickeners based on aluminium silicate.

17. The method as claimed in claim 13 wherein the suspension concentrate comprises one or more thickeners based on aluminium silicate.

18. The method as claimed in claim 14 wherein the suspension concentrate comprises one or more thickeners based on aluminium silicate.
